(19) United States
(12) Patent Application Publication
(10) Pub. No.: US 2003/0009691 A1
(43) Pub. Date: Jan. 9, 2003

(54) Centralized clearinghouse for entitlement information

(76) Inventors: Martha L. Lyons, Sunnyvale, CA (US); Michelle Kathleen Vendelin, Los Altos, CA (US)

Correspondence Address: HEWLETT-PACKARD COMPANY, Intellectual Property Administration, P.O. Box 272400, Fort Collins, CO, 80527-2400, US

(21) Appl. No.: 09/900,070

(22) Filed: Jul. 6, 2001

(51) Int. Cl. H04L 9/32

(52) U.S. Cl. 713/201

(57) ABSTRACT

The present invention is directed to a system and method which provides a centralized clearinghouse of entitlement information that can preferably be accessed and used by any authorized entitlement provider, whether providing service over the Internet or through a tangible facility. A preferred embodiment preferably includes a database for storing entitlement and access information provided by the entitlement party or enterprise. The system preferably also comprises a centralized, network-accessible facility that allows any type of entitlement service provider or supplier to access for verifying entitlements for customers. The clearinghouse interface is preferably secured to prevent unauthorized access or tampering by any unauthorized entitlement service provider or supplier. Also, a data structure is preferably used to search the database for the entitlement and access information based on data provided by accessing service providers or suppliers.

### BACKGROUND

The Internet has forever changed the manner and methods in which commerce takes place across the world. Consumers and businesses desiring to engage in any type of commerce routinely use the Internet to perform research, engage a vendor, and even make the purchases. Conversely, vendors use the Internet as a marketing tool for providing advertising, accessibility, and an overall increase in the potential market for their goods and/or services. The tremendous growth in Internet commerce may generally be attributed to the increases in on-line security technology and to the increased availability of Internet resources. Authenticating and verifying individuals' identities, companies, credit cards, and the like is generally paramount to ensuring the safety and security of any Internet transaction. It is likely that Internet commerce would not have taken off in the manner it did without such improvements in security.

The Internet is now seeing a resurgence of commerce in the service sector. Customers may purchase subscriptions to news or business services that may offer varying levels of access based on the particular level or costs of the service plan purchased. Some services may limit a user based on the numbers of times the user accesses the service site, while other services may limit the user based on a range of dates, or the completeness of the information accessed. Commensurate which such limitations, comes the logistics of managing the list of entitlements to each participating user.

An added consideration generally arises when one Internet service provider teams up with another one or several service providers to offer a wide variety of different combinations or levels of combinations of services. In such circumstances, each individual service provider may also maintain separate service offerings outside of the various partnerships. In these situations, the management of the different and various entitlements for the different service providers may create a bottleneck in the timely provision of the different levels of services. Each service provider typically maintains its own database of entitlement information. Each such database and/or entitlement management system may also comprise proprietary software, thus requiring any entity desiring access to the entitlement system to do so using the proprietary format. Contract management systems have been developed to assist in managing, analyzing, and ranking contracts, as shown in commonly assigned, co-pending U.S. patent applications Ser. No. 09/573,966, entitled “SYSTEM AND METHOD FOR CO-TERMINATION OF PRODUCT SUPPORT CONTRACTS,” filed May 19, 2000; and U.S. patent application Ser. No. 09/664,890, entitled “SYSTEM FOR ANALYZING AND RANKING PRODUCT SUPPORT CONTRACTS,” filed Sep. 19, 2000, the disclosures of which are hereby incorporated herein by reference.

In addition to increasing commerce, the Internet has also generally allowed for cheap and reliable connection and communication between anyone with computer/Internet access. E-mail, dial-up and direct server connections, peer-to-peer networking, and the like each typically bring automation and ease of communication to anyone connected or able to connect to the Internet. Therefore, traditionally non-electronic, non-Internet businesses and/or services have generally been able to leverage the connectivity of the Internet into faster, better information. For example, a tire store typically used to have access only to its own inventory. To find out another branch store's inventory, the one store had to rely on a clerk placing a telephone call to the other branch. With peer-to-peer networking or server-based networking, the first store may now typically use the computer and either an Internet connection or a dedicated network connection to view the inventory of any related store or branch. In some instances, the store may also have access to manufacturers' ordering systems. Thus, the Internet typically allows the smaller companies to enjoy the computerization levels and connectivity previously available only to the larger companies.

Traditionally non-Internet service providers also typically sell various levels of services to their customers. In the tire store example, the store may sell a lifetime balance and rotation service contract to one customer and then sell a limited road hazard warranty to the next customer. If either of those customers returns for service, each has certain entitlement to some level of service. Typically, the customer or the company will maintain a certificate, receipt, or file that indicates the level of service the customer is entitled to. However, the customers, and sometimes even the businesses, will lose or throw out such receipts or certificates. Furthermore, if the customer purchased the service contract at one branch of the store and then wants to obtain service at a different branch or even in a different branch in a different city or country, the new branch may or may not have any means to access the records of the original store other than by calling and hoping that the original store maintained proper records. In the case of attempting to redeem such entitlement services in a foreign country, it may be impossible to provide timely verification of the customer's entitlement. Additionally, if service was delivered by an alternate source, there would typically be no way to securely update the entitlement usages and/or fulfillment information. Furthermore, as entitlements are fulfilled, they need to reflect such or they can usually age, expire, and/or be renewed.

### SUMMARY OF THE INVENTION

In consideration of the problems and deficiencies present in the current ways to provide verification and/or management of entitlements, it would be desirable to have a centralized clearinghouse of entitlement information which could be accessed by any participating entitlement service provider to verify entitlement to a service. The present invention is directed to a system and method which provides such a centralized clearinghouse of entitlement information that can be accessed and used by any authorized entitlement supplier, whether providing service over the Internet or through a physical store-front and whether the entitlement provider is a physical business or some form of automated service, such as an automated e-Service.

A preferred embodiment of the present inventive entitlement authority would preferably include a database for storing entitlement information provided by the entitlement party or enterprise. The entitlement parties or enterprises preferably cause the assembly of the list of stored entitlement and access information by entering such information into the system. The system would preferably comprise a centralized, network-accessible facility that allows any type of entitlement service provider or supplier to use for verifying and/or updating entitlements. In order to assure the integrity of the system, it would preferably have a secure access point for authorized entitlement service providers and suppliers to use for interacting and interfacing with the entitlement verification service. Through interaction with the inventive system, the entitlement service providers and suppliers would preferably trigger a data structure for searching through the database for the requested entitlement information or to verify the presence of such entitlement information. Thus each entitlement service provider and/or supplier is capable of performing searches of the entire entitlement database to determine the level of a customer's entitlement. The concept of providing a centralized clearinghouse has been applied to a certain extent in the area of identity information for electronic communities as shown in commonly-assigned, co-pending U.S. patent application Ser. No. 09/774,727, entitled “CENTRALIZED CLEARINGHOUSE FOR COMMUNITY IDENTITY INFORMATION,” filed Jan. 31, 2001, the disclosures of which is hereby incorporated herein by reference.

### BRIEF DESCRIPTION OF THE DRAWING

FIG. 1 is a block diagram illustrating a preferred embodiment of the present invention;

FIG. 2 is a block diagram illustrating a preferred embodiment of the present invention connected to several users of the inventive system;

FIG. 3 is a block diagram illustrating a preferred embodiment of the present invention in an alternative connection configuration;

FIG. 4 is a block diagram illustrating an alternative embodiment of the present invention configured with interactive voice technology for interfacing with telecommunication equipment; and

FIG. 5 is a flowchart describing the steps used to perform the method implementing a preferred embodiment of the present invention.

### DETAILED DESCRIPTION

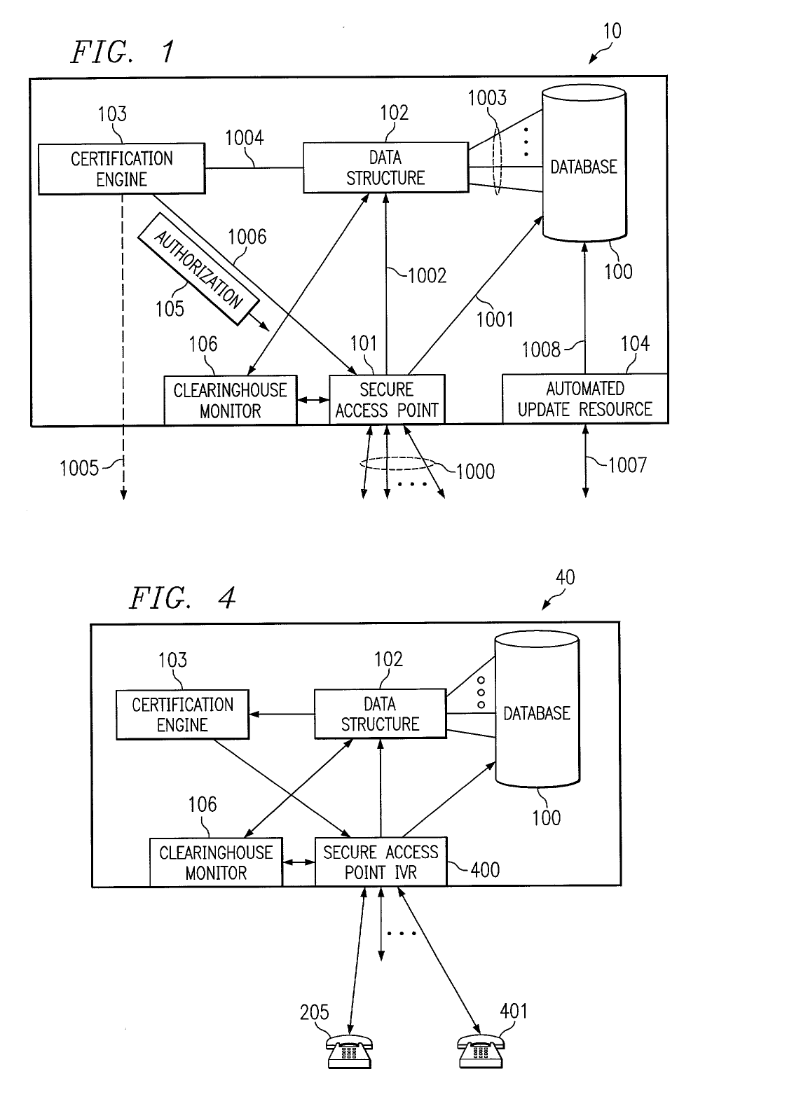

FIG. 1 illustrates a preferred embodiment of the present invention. Clearinghouse 10 provides a centralized repository for entitlement enterprises to store various entitlement information representing entitlement to services. Such information may comprise terms and conditions of use, expiration dates, number of uses, subscription periods, perpetual use conditions, usage limitations, different authorized users with their identities and the like. It may also preferably include delivery instructions or purchase dates and any exceptions, along with access information supplied by entitlement enterprises to specify particular service providers and/or classes of service providers that are authorized to access clearinghouse 10. It may also preferably include access information for users to access clearinghouse 10 in order to provide summaries or lists of the user's entitlements. Access information may preferably comprise names, account numbers, customer numbers, contract numbers, vendor numbers, and the like. The entitlement and access information is preferably stored in database 100.

Access to clearinghouse 10 is preferably controlled via secure access point 101. Secure access point 101 preferably provides an outside interface via trunk 1000. Trunk 1000 may generally comprise a T1, T3, or other telecommunication line, an integrated services digital network (ISDN) line, a fiber optic connection, a wireless connection, or other means to provide multimedia communications connections. Secure access point 101 may also include any number of various physical layer security measures to control access to clearinghouse 10, such as firewalls, computer controlled switches, and the like.

Secure access point 101 preferably works in tandem with clearinghouse monitor 106 in order to facilitate the connections to clearinghouse 10. Clearinghouse monitor 106 preferably comprises processing capability with soft- and firmware to control the security and the accessibility to clearinghouse 10 through security access point 101. If accessing via the Internet, clearinghouse monitor 106 may incorporate secure sockets layering (SSL) technology. In an SSL session, the server typically sends its public key to the accessing browser. The browser usually uses the server's public key to send a randomly-generated secret key back to the server in order to have a secret key exchange for that session. Another alternative security measure for electronic access is transport layer security (TLS) which merges SSL with other types of security protocols such as triple data encryption standard (Triple DES). DES generally uses a secret key cryptography with a 56-bit key. DES uses a block cipher method which generally separates any text or information into 64-bit blocks before encryption. Triple DES uses three keys and encrypts the blocks three times.

Secure access point 101 may preferably receive the access entry signals and communicates those signals to clearinghouse monitor 106. Clearinghouse monitor 106 then preferably compares the access entry signals to the access information stored on database 100. Other manners of access, such as with a telephone, may incorporate private key or password access to clearinghouse 10. If such access manner utilizes voice communication, it may also preferably use voice-print identification technology to authenticate and verify access to clearinghouse 10. As the costs for high speed processing and storage decreases, it would generally be more affordable to implement such voice-print identification technology.

In operation, a user would preferably set up a base voice print in clearinghouse monitor 106 using the physical hardware and physical connection provided by secure access point 101. This may either entail storing a digitally analyzed version of the voice or a digitized wave file representing the voice. When the user subsequently calls into clearinghouse 10, secure access point 101 preferably samples the voice command and communicates the sample to clearinghouse monitor 106, which would preferably compare the live spoken password against the base voice print in order to verify the identity of the user. It should be noted that any other types of security measures or any combination thereof may be chosen to implement the security measures in clearinghouse monitor 106 and secure access point 101.

Entitlement enterprises access clearinghouse 10 to preferably update, modify, and/or amend the entitlement and access information. After accessing the system through secure access point 101, the entitlement enterprise or party preferably enters the appropriate entitlement and access information, which is then stored in database 100 over path 1001. Once all the appropriate entitlement and access information has preferably been transferred to database 100, the entitlement enterprise preferably disconnects from clearinghouse 10.

Entitlement service providers also preferably access clearinghouse 10 through secure access point 101. Upon access to secure access point 101, clearinghouse 106 verifies the service providers authorization to access clearinghouse 10 by preferably comparing and/or searching database 100 for the appropriate access information stored therein. Authorized service providers, which in some circumstances may be the entitlement enterprise acting as the provider, typically would then access clearinghouse 10 when a customer is attempting to obtain services based on some form of entitlement, such as a warranty, subscription, e-service usage or the like. The entitlement service provider preferably enters the information or data necessary to identify itself, a particular customer, and also to identify the service entitlement corresponding to the particular customer. This information is preferably transferred over path 1002 to data structure 102. Data structure 102 preferably links to database 100 over paths 1003. Data structure 102 preferably includes search algorithms connected to the memory and storage structure of database 100 in order to perform time- and processing-efficient searches to verify the customer's entitlement.

Data structure 102 preferably conducts a search of database 100 using the information entered by the entitlement service provider. As data structure 102 finds matches or other indications to verify entitlement, these search results are preferably communicated to certification engine 103 to verify that the information entered by the entitlement service provider matches the entitlement information stored on database 100. Once certification engine 103 verifies the entitlement results, it preferably sends authorization 105 to the entitlement service provider at secure access point 101 over path 1006. Authorization 105 may comprise a simple “affirmed” or “denied” signal, depending on the results of the search. Authorization 105 may also preferably comprise any number of different codes or signals to represent different levels of authorization or more details regarding the entire entitlement of the user. The entitlement service provider then preferably receives authorization 105 over trunk 1000. Depending on the content of authorization 105, the entitlement service provider may either receive a verification of entitlement or a notice that the verification attempt failed.

It should also be noted that in alternative embodiments of the present invention, when services are delivered, the entitlement service provider may preferably be allowed access to clearinghouse 10 for updating and/or amending the entitlement information by changing entitlement values or adding information regarding the fulfillment of the service, such as what services were delivered by whom, and the like.

It should be noted that in alternative embodiments of the present invention, entitlement service providers may preferably receive entitlement verification from clearinghouse 10 without having to maintain a connection through trunk 1000. In such an alternative embodiment, the entitlement service provider preferably accesses clearinghouse 10 in the manner described above. However, after entering the appropriate identification information or data, the service provider may then preferably disconnect from clearinghouse 10. In this alternative embodiment, when certification engine 103 verifies the results of the search, it preferably independently sends a result communication, which may comprise an entitlement authorization, a decline of entitlement, an authorization code that represents a particular level of access or entitlement, or the like. The search result is preferably communicated from clearinghouse 10 over alternative path 1005. Alternative path 1005 may comprise a confirmation e-mail sent to the entitlement service provider's e-mail address, it could comprise a telephone call with a pre-recorded message played to the service provider indicating the particular search results, it could also comprise a page containing a pre-defined code, or it could take any other form of communication that can be automated and controlled from clearinghouse 10.

In a further alternative embodiment, it may be desirable to establish an automated method to maintain the accuracy of the entitlement information stored on database 100. In such an alternative embodiment, clearinghouse 10 would preferably further include automated update resource 104, which may include an automated processor with communication capabilities such as a dedicated modem, high speed access line, network connection, or other such communication avenues. During the phase in which an entitlement enterprise sets up a service with clearinghouse 10, clearinghouse 10 would preferably require any connection information for the entitlement enterprises computer system. Periodically, automated update resource 104 would preferably establish communication with the entitlement entity over path 1007 to update and exchange new entitlement and access information. Automated update resource 104 would then preferably store the new or amended entitlement and access information directly to database 100. In such an alternative embodiment, the entitlement and access information preferably remains current and up-to-date.

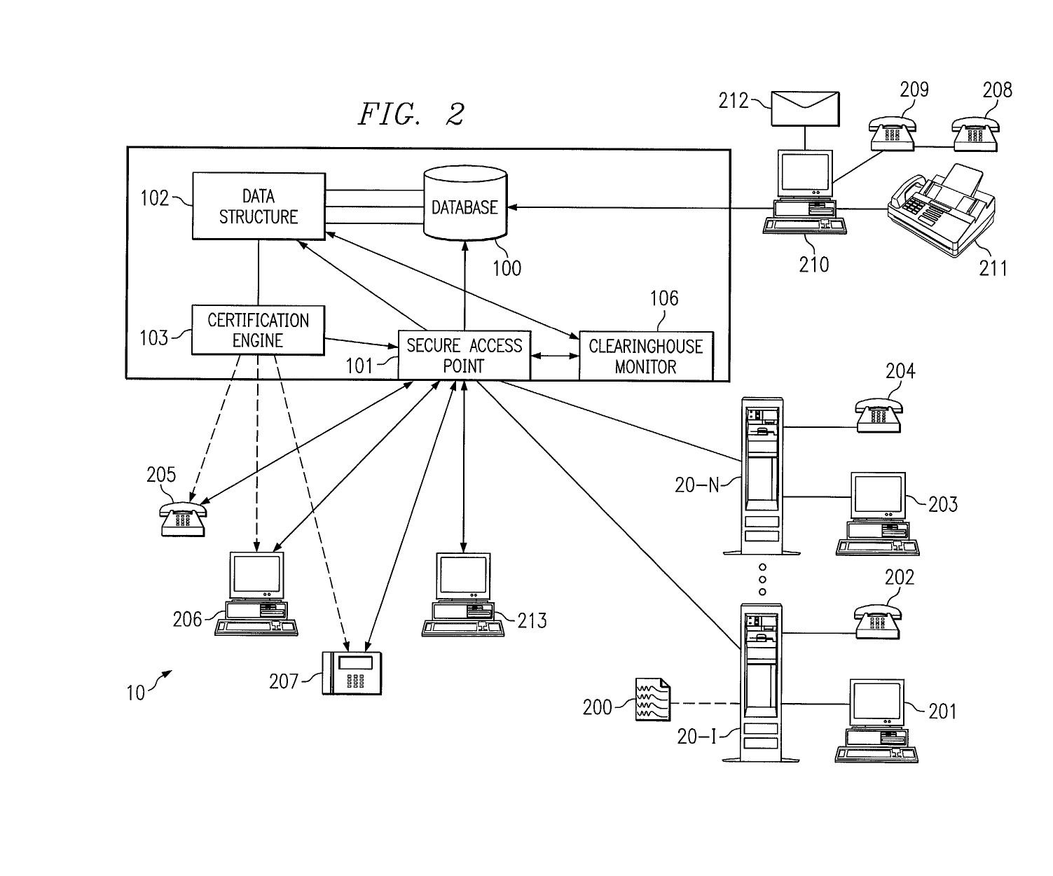

FIG. 2 shows a block diagram of the preferred embodiment of the present invention along with several connections to entitlement service providers and entitlement parties or enterprises. In operation, the inventive entitlement authority begins by compiling the list of entitlement information. Entitlement enterprises 20-1 through 20-N are entities which advertise and perhaps sell automated services, service contracts, guarantees, warranties, and the like to customers. Entitlement enterprises 20-1 through 20-N gather entitlement information by signing up or registering customers to receive some kind of service. Customers may be registered using any communication methods available to entitlement enterprises 20-1 through 20-N. One customer may register by completing form 200. Form 200 may then be scanned or manually entered into entitlement entity 20-1.

Customers may also preferably register using computers connected to a network, the Internet, or some other open or private data network, whether the computers are provided by entitlement enterprises 20-1 through 20-N or are the customers' computers. The customers enter data on computers 201 and 203 that is stored onto entitlement enterprises 20-1 through 20-N. Entitlement and access information for a customer may also be entered using telephones 202 and 204. With telephones 202 and 204, the user may speak to an operator or agent to enter the information, may speak into an interactive voice response (IVR) system that incorporates advanced speech recognition (ASR) technology, may enter data using dual tone multiple frequency (DTMF) key sequences, or any other communication method compatible with a telephone.

Entitlement entities 20-1 through 20-N have previously set up service to use clearinghouse 10 as the central repository for verifying its entitlements. As entitlement entities 20-1 through 20-N develop the lists of entitlement information, they establish communication sessions with clearinghouse 10 by accessing secure access point 101 and clearinghouse monitor 106. After providing the appropriate security information, entitlement entities 20-1 through 20-N download the gathered entitlement information to database 100. Once all of the entitlement information has been downloaded for a particular session, entitlement entities 20-1 through 20-N end that communication session.

Entitlement entities 20-1 through 20-N may find it beneficial to outsource the provision of services that it offers. For example, a computer company selling an extended service contract may actually contract with an unrelated computer repair business to supply the services according to the extended service contract. Additionally a software company may sell a subscription to updates or additions for a specified length of time or other measurable limit. While the company may sell the subscription, other parties may actually store the updates and facilitate the downloads or provision of the updates to the user. In the same manner entitlement entities 20-1 through 20-N may outsource to entitlement service providers 205, 206, and 207. As customers seek to redeem services, they go to any of the appropriate entitlement service providers 205, 206, and/or 207, which could be physical store-fronts, call centers, service websites, and the like. If entitlement service providers 205, 206, and/or 207 have been designated in the employment enterprise-supplied access information, entitlement service providers 205, 206, and/or 207 are preferably allowed access to clearinghouse 10 to determine the level of service that the customer is entitled to before rendering the services.

It should also be noted that in an alternative embodiment of the present invention, after the services have been delivered, entitlement service providers 205, 206, and/or 207 are also preferably allowed access to clearinghouse 10 to update or amend the entitlement information with data related to the delivery of the service. For example, if entitlement service provider 205 is providing service to a user who has an entitlement for a specific number of services, entitlement service provider 205 may access clearinghouse 10 after such services have been delivered, to record the delivery of such service. Clearinghouse 10, thus, updates the entitlement information to decrement the number of times such a service is available to the user. Entitlements based on other types of limitations, such as duration of time, level of cost, and the like may also preferably be updated by entitlement service providers 205, 206, and/or 207 in such an alternative embodiment.

It should be noted that an alternative embodiment of the present invention would preferably allow entitlement services to be provided by any service provider authorized to access the entitlement clearinghouse/authority. Thus, the computer company referred to above would not necessarily have to enter into specific outsourcing contracts for the performance of the service contract or download access information to the entitlement clearinghouse for a specific entitlement service provider. Rather, the entitlement enterprises would preferably approve access based on a type of service provided by the entitlement service provider. In such embodiments, the access information may preferably correspond to a service code available to all companies that provide such services.

Returning to FIG. 2, entitlement service provider 205 preferably accesses clearinghouse 10 using a telephone. All data exchanged between entitlement service provider 205 and clearinghouse 10 will, therefore, preferably be in a format compatible with a telephone (e.g., verbal, series of tones, and the like). Entitlement service provider 206 preferably accesses clearinghouse 10 using a computer connection, whether connected over the Internet or to a dedicated dial-up connection. Entitlement service provider 207 uses a specialized electronic device to provide access and interaction with clearinghouse 10. Such devices may be comparable to the credit/debit card keypads found in grocery stores and the like.

It should be noted that entitlement service providers and users may want to view a collection or list of all entitlements or access privileges they may have. In such embodiments of the present invention, the entitlement service providers and/or users would preferably access clearinghouse 10 at secure access point 101 and clearinghouse monitor 106, clearinghouse monitor 106 may then preferably interact with the entitlement service provider and/or user to determine that they wish an informational summary of each entitlement and/or access entitlement from clearinghouse 10.

For example, in FIG. 2, user 213 may preferably access clearinghouse 10 through secure access point 101. User 213 interacts with clearinghouse monitor 106 to preferably indicate the desire for a list of entitlements available to user 213. Clearinghouse monitor 106 preferably accesses data structure 102 to find all entitlement information corresponding to user 213 stored in database 100. Once the entitlement information is found, clearinghouse monitor 106 assembles it into a list which is then communicated to user 213 through secure access point 101.

Similarly, entitlement service provider 206 may also preferably access clearinghouse 10 through secure access point 101 to obtain a list of all access entitlements corresponding to entitlement service provider 206. Entitlement service provider 206 interacts with clearinghouse monitor 106 to preferably establish the desire for such a list of access entitlements. Clearinghouse monitor 106 preferably accesses data structure 102 to find all access information corresponding to entitlement service provider 206 stored in database 100. Once the access information is found, clearinghouse monitor 106 assembles it into a list which is then communicated to entitlement service provider 206 through secure access point 101.

In an example of application, entitlement service provider 207 may be a video store. Entitlement enterprise 20-1 sells a customer a service card allowing the customer to obtain a certain number of free movie rentals. The service card may provide different numbers of free rentals depending on the customer's affiliations, job, or purchase price. As the customer visits entitlement service provider 207, the customer would preferably swipe his or her service card in the card reader to transfer the necessary identification data to entitlement service provider 207. Entitlement service provider 207 then securely logs onto clearinghouse 10 preferably through secure access point 101 and clearinghouse monitor 106. When the communication link has been verified and established, the identification data from the card is preferably transferred to data structure 102. Data structure 102 searches database 100 for matching information which would verify that the customer was entitled to receive the free video rental service.

The results of the search are then preferably forwarded to certification engine 103 in order to certify the entitlement information. Certification engine 103 then preferably communicates the certified entitlement information to entitlement service provider 207. The certified entitlement information may comprise several formats as described above, such as a single authorization if the entitlement information is valid. It may also comprise an authorization code that, in this example, may represent the number of free rentals remaining on the customer's entitlement access. Similarly, the certified entitlement information may preferably be communicated to entitlement service provider 207 either through a continuing communication link through secure access point 101 or through a separate communication initiated from clearinghouse 10 at certification engine 103 sent directly to entitlement service provider 207.

Because clearinghouse 10 is preferably a centralized repository accessible by any entitlement service provider authorized for access, the entitlement verification system provided may preferably extend to multiple entitlement service providers providing services for any number of different and unrelated entitlement enterprises or entitlement parties. Thus, extending the above example, the service card issued by entitlement enterprise 20-1 to the customer may allow the customer to obtain free video rental at several unrelated video stores, such as entitlement service providers 206 and 205. As long as entitlement service providers 206 and 205 are authorized to access clearinghouse 10, the entitlement associated with the customer's card will preferably be verified no matter what service provider he or she goes to.

It should be noted that in alternative embodiments of the present invention, unrelated service providers may also preferably amend and/or update the entitlement information, where appropriate, through controlled access to clearinghouse 10.

Similarly, competing entitlement enterprises may provide entitlement packages that are usable at many different service provider locations. Expanding again on the above example, entitlement enterprise 20-N may also sell free video rental entitlements that may be evidenced by a password or combination of password and user ID. A customer with an entitlement card issued from entitlement enterprise 20-1 and a customer with a password and user ID from entitlement enterprise 20-N may both preferably obtain the entitlement services from entitlement service provider 206, as long as entitlement service provider 206 has been designated or fits within the designation by entitlement enterprise 20-N. Because both sets of entitlement information have preferably been stored onto database 100, authorized entitlement service providers 205 and 206 would preferably be able to verify the customers' entitlement to the service through clearinghouse 10.

In an alternative embodiment of the present invention, clearinghouse 10 includes the facilities for preferably allowing entitlement entities to submit written or visual entitlement information for manual entry into database 100. Controlled access computer terminal 210 maintains a direct connection to database 100. An operator at terminal 210 may preferably manually enter any data directly into database 100. Using telephone 209 an operator may talk with a person at entitlement enterprise 208 and manually enter any entitlement information that is verbally received directly into database 100. Furthermore, a person at entitlement entity 211 may fax entitlement information that appears on the operators display of terminal 210. The operator is, again, able to manually enter the entitlement information directly to database 100. A person at entitlement enterprise 212 may preferably mail written entitlement information to the operator that may also be manually entered at terminal 210 directly into database 100.

It should be noted that secure access point 101 and clearinghouse monitor 106 preferably receive entitlement use data from accessing entitlement service providers in order to update any entitlement information that depends on use. For example, entitlements based on number of uses will be decremented by clearinghouse monitor 106 when it receives entitlement use information from any entitlement service provider. Similarly, as entitlement enterprises 20-1 through 20-N access clearinghouse 10 to download new and revised entitlement information, clearinghouse monitor 106 adds the new entitlement information and also changes or deletes old entitlement information that is no longer valid according to the revised entitlement information received from entitlement enterprises 20-1 through 20-N.

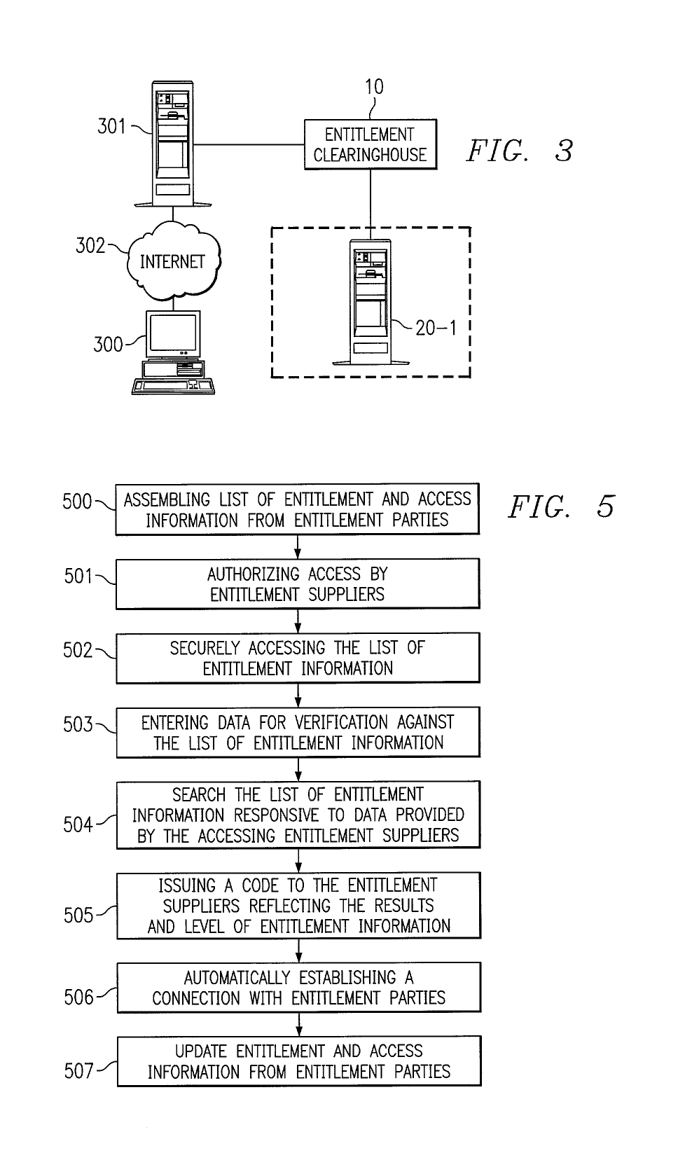

FIG. 3 is a block diagram illustrating an alternative connection configuration for a preferred embodiment of the present invention. In another example of operation, a user may subscribe to an automated service, such as a subscription for virus software updates. User 300 signs up with virus software company 20-1 for a certain period of time, a certain number of updates, or the like. However, virus software company 20-1 may not provide the servers necessary to keep user 300 up to date with the latest software updates. Thus, software company 20-1 may preferably contract with entitlement supplier 301 to provide authorized users, such as user 300, the updated software. When user 300 contacts entitlement supplier 301, possibly using Internet 302, to receive the subscription update, entitlement supplier 301 preferably accesses entitlement clearinghouse 10 to verify the level of user 300's entitlement. Based on the entitlement information received from clearinghouse 10, entitlement supplier 301 preferably downloads the appropriate updates to user 300. As user 300 uses up all of the subscribed services, entitlement supplier 301 eventually stops providing the updates when the entitlement information from entitlement clearinghouse 10 preferably indicates that user 300 is no longer entitled to such automated services.

FIG. 4 is a block diagram illustrating an alternative embodiment of the present invention. As described above, the present invention allows for centralized access to entitlement information verification by any type of entitlement service provider, whether that provider is an Internet service provider, or a provider located at a tangible facility providing typically non-electronic services. Entitlement authority 40 includes secure access point IVR 400 that facilitates verbal interaction with not only entitlement service providers, such as entitlement service provider 205, but also with non-computerized entitlement parties, such as entitlement party 401.

Secure access point IVR 400 provides interactive voice response functionality to entitlement authority 40. Therefore, in addition to electronic access as described in the previous embodiments, the alternative embodiment incorporating secure access point IVR 40 also allows verbal interaction for each step of the entitlement information verification process. Entitlement party 401 may preferably call an access phone number for entitlement authority 40, speak or enter a DTMF password into the phone, and then either speak or use DTMF signals to enter all necessary entitlement information into database 100 through secure access point IVR 400. Entitlement service provider 205 may also access entitlement authority 40 through an access phone number. By speaking or using DTMF signals to interact and provide identification data, data structure 102 searches database 100 for the entitlement information corresponding to the data entered. Certification engine 103 may then provide the results to secure access point IVR 400 to be converted into a pre-recorded or synthesized voice response indicating the results of the verification search to entitlement service provider 205. Thus the results of the entitlement verification search may be presented verbally to entitlement service provider 205.

FIG. 5 is a flow chart illustrating the steps typically performed in implementing a preferred embodiment of the present invention. In step 500, a list of entitlement information and access information from entitlement parties is preferably assembled. Any party attempting to access the entitlement authority, including any entitlement service providers, are authorized for access in step 501. In step 502, the list of entitlement information is securely interacted with and accessed by entitlement suppliers. The suppliers enter data for verification against the entitlement information stored in the list, in step 503. In step 504, the list of entitlement information is searched responsive to the data provided by the accessing entitlement suppliers. In step 505, a code representing the results of the search and corresponding to the level of entitlement found in the entitlement information list is communicated to the entitlement suppliers.

It should be noted that in alternative embodiments of the present invention, the entitlement authority automatically establishes communication connections with the entitlement enterprises in step 506. Once such connections have been established, the entitlement and access information stored in the lists is updated with the information from the entitlement enterprise in step 507.

What is claimed is:

1. A clearinghouse for providing verified entitlement information to at least one entitlement service provider, said clearinghouse comprising:
a database for receiving said entitlement information from an entitlement enterprise;
a secure access point for authorized ones of said at least one entitlement service provider to interactively access said clearinghouse;
a clearinghouse monitor for controlling access to said clearinghouse from said secure access point responsive to access information provided by said entitlement enterprise; and
a data structure for searching said database for entitlement information responsive to data provided by said entitlement service provider.

2. The clearinghouse of claim 1 further comprising:
a certification engine for providing certified results from said data structure search.

3. The clearinghouse of claim 1 further comprising:
an authorization communicated to said entitlement service provider responsive to said data structure finding said entitlement information and revised access information.

4. The clearinghouse of claim 1 further comprising:
an automated update resource for initiating communication with said entitlement enterprise to obtain revised entitlement information.

5. The clearinghouse of claim 1 wherein said secure access point includes a controlled access computer terminal for manually entering entitlement information provided by said entitlement enterprise.

6. The clearinghouse of claim 1 wherein said secure access point includes an interactive voice response (IVR) unit for facilitating verbal access to said clearinghouse.

7. The clearinghouse of claim 1 wherein said clearinghouse monitor compiles lists of entitlement information corresponding to a user responsive to a request from said user.

8. The clearinghouse of claim 1 wherein said clearinghouse monitor compiles lists of access information corresponding to ones of said at least one entitlement service provider responsive to a request from said ones of said at least one entitlement service provider.

9. A method for verifying entitlement, comprising the steps of:
assembling a list of entitlement information from entitlement parties;
authorizing access to said list of entitlement information based on corresponding access information;
providing entitlement service suppliers with authorization secure access to said list; and
searching said list for entitlement responsive to identification data provided by said entitlement service suppliers.

10. The method of claim 9 further comprising the step of:
issuing a code to said entitlement service suppliers indicative of results of said searching step.

11. The method of claim 9 further comprising the step of:
verifying entitlement for said entitlement service suppliers responsive to finding said entitlement in said searching step.

12. The method of claim 9 wherein said assembling step comprises the steps of:
accessing said list of entitlement information by said entitlement parties with authorization; and
transmitting said entitlement information from said entitlement parties to said list of entitlement information.

13. The method of claim 9 wherein said assembling step comprises the steps of:
receiving entitlement information from said entitlement parties; and
manually entering said entitlement information onto said list of entitlement information.

14. The method of claim 9 further comprising the step of:
updating said list of entitlement information responsive to entitlement use information transmitted by said entitlement service suppliers with authorization

15. The method of claim 9 further comprising the steps of:
automatically establishing a communication connection between said list of entitlement information and said entitlement parties with authorization;
obtaining revised entitlement information from said entitlement parties; and
updating said list of entitlement information with said revised entitlement information.

16. The method of claim 9 further comprising the steps of:
compiling a list of entitlement information corresponding to a user; and
presenting said list of entitlement information to said user.

17. The method of claim 9 further comprising the steps of:
compiling a list of access information corresponding to one of said entitlement service suppliers; and
presenting said list of access information to said one of said entitlement service suppliers.

18. An entitlement authority for verifying entitlement information comprising:
means for receiving said entitlement information and access information from an entitlement party;
means for storing said entitlement information and said access information;
means for securing an interface to said entitlement authority;
means for authorizing access to said entitlement authority responsive to said access information;
means for receiving data from an entitlement service provider for verifying entitlement;
code for searching said stored entitlement information using said data;
means for providing results of said searching; and
means for updating said stored entitlement information.

19. The entitlement authority of claim 18 wherein said means for receiving steps and said means for providing step include means for providing voice interaction with said entitlement authority.
